(19) United States
(12) Patent Application Publication
(10) Pub. No.: US 2024/0213439 A1
(43) Pub. Date: Jun. 27, 2024

(54) LASER PROCESSING METHOD

(71) Applicant: Prime Planet Energy & Solutions, Inc., Tokyo (JP)

(72) Inventor: Haruhiko YAMAMOTO, Nisshin-shi (JP)

(21) Appl. No.: 18/500,112

(22) Filed: Nov. 2, 2023

(30) Foreign Application Priority Data
Dec. 23, 2022 (JP) 2022-207121

(51) Int. Cl. H01M 4/04; B23K 26/142; B23K 26/38

(52) U.S. Cl. CPC H01M 4/0471; B23K 26/142; B23K 26/38; B23K 2101/38

(57) ABSTRACT

A laser processing method for an electrode is provided that can suppress reduction in a light condensing property for a laser due to a dust, such as fume, while suppressing vibration at a laser processing time. By the present disclosure, a method for performing a laser processing on a strip-like shaped electrode is provided. The herein disclosed method includes carrying the strip-like shaped electrode to a previously set processing area in a longitudinal direction, and includes performing laser radiation on a surface of the electrode in the processing area under a state where a first air flow configured to flow on one surface of the electrode and a second air flow configured to flow on the other surface of the electrode are formed.

### CROSS REFERENCE TO RELATED APPLICATIONS

The present application claims the priority based on Japanese Patent Application No. 2022-207121 filed on Dec. 23, 2022, and the entire contents of which are incorporated in the present specification by reference.

### BACKGROUND OF THE DISCLOSURE

### 1. Technical Field

The present disclosure relates to a laser processing method. For more detail, the present disclosure relates to a laser processing method for a strip-like shaped electrode that is used in an electric storage device.

### 2. Background

An electric storage device, such as secondary battery, might include a strip-like shaped electrode. Typically, the electrode includes an electrical collector foil made of metal, and includes active material layers arranged on both surfaces of the electrical collector foil. At an end part of the electrical collector foil, an electrical collector foil exposed part is provided on which an active material layer is not arranged. To the electrical collector foil exposed part, an electrical collector member is connected so as to form a conduction path.

The electrical collector foil exposed part can be processed by a laser processing, or the like, so as to be at least a part of a tab. At that time, reaction force at a time, when a dust, such as fume, generated on the electrode due to a laser radiation is scattered, makes the electrode vibrate in a thickness direction. By doing this, there is a case where a focal point of a laser light is deviated from the electrode. With respect to this circumstance, for example, Japanese Patent Application Publication No. 2022-82035 discloses a laser processing apparatus that can precisely cut a strip-like shaped electrode. This laser processing apparatus includes a guide configured to hold a periphery of a laser processing position of the strip-like shaped electrode. This guide sandwiches the strip-like shaped electrode in a thickness direction of it. By doing this, it is supposed that fluttering (vibration) of the strip-like shaped electrode can be suppressed.

### SUMMARY OF THE INVENTION

Anyway, in a case where the dust, such as fume, generated at the laser processing performed on the electrode, is scattered into a path of the laser light, the laser light is diffused and thus a light condensing property for the laser light might be deteriorated. Additionally, in a case where a guide, or the like, is arranged at the periphery of the laser radiation part, the dust, such as fume, might stick to the guide, or the like, so as to likely cause a damage on the electrode.

Therefore, the present disclosure has been made in view of the above-described circumstances, and a main object is to provide a laser processing method for an electrode in which the vibration at the laser processing time can be suppressed, and further in which reduction in the light condensing property of the laser due to the dust, such as fume, can be suppressed.

The present disclosure provides a method for performing a laser processing on a strip-like shaped electrode. The herein disclosed method includes carrying the strip-like shaped electrode to a previously set processing area in a longitudinal direction, and performing a laser radiation on a surface of the electrode in the processing area under a state where a first air flow configured to flow on one surface of the electrode and a second air flow configured to flow on the other surface of the electrode are formed.

Regarding the method, the air flows configured to flow on the both surfaces of the strip-like shaped electrode are formed in the processing area, and thus the air flows can support the strip-like shaped electrode as if they sandwich the strip-like shaped electrode from the thickness direction. Thus, even if the dust, such as fume, is generated by the laser radiation, it is possible to suppress the strip-like shaped electrode from vibrating in the thickness direction on the laser radiation part. In addition, the dust, such as fume, blows away by the air flows, and thus it is possible to suppress the reduction in the light condensing property of the laser light.

### BRIEF DESCRIPTION OF THE DRAWINGS

FIG. 1 is an exploded view that schematically shows a configuration of an electrode assembly.

FIG. 2 is a front view that schematically shows a configuration of a laser processing apparatus.

FIG. 3 is a side view that schematically shows the configuration of the laser processing apparatus.

### DETAILED DESCRIPTION OF THE PREFERRED EMBODIMENTS

Below, a herein disclosed technique will be described in detail. The matters other than matters particularly mentioned in this specification, and required for practicing the present disclosure can be grasped as design matters of those skilled in the art based on the conventional technique in the present field. Contents of the herein disclosed technique can be executed based on the contents disclosed in the present specification, and the technical common sense in the present field.

Incidentally, each figure is schematically drawn, and the dimensional relation (such as length, width, and thickness) does not reflect the actual dimensional relation. Additionally, in figures described below, the same numerals and signs are given to the members/parts providing the same effect, and overlapped explanations might be omitted or simplified. Thus, for example, a reference sign applied to an electrode (finished product) explained below and a reference sign applied to a strip-like shaped electrode before a laser processing are the same. Additionally, in the present specification, when a numerical value range is represented by “A to B (here, A and B are arbitrary values)”, it means “equal to or more than A and not more than B” and furthermore semantically covers meanings of “exceeding A and less than B”, “exceeding A and not more than B”, and “equal to or more than A and less than B”.

Incidentally, a term “electric storage device” in the present specification represents a device that can perform electrical charging and electrical discharging. The electric storage device can semantically cover a battery, such as primary battery and secondary battery (for example, lithium ion secondary battery, or nickel hydrogen battery), and a capacitor (physical battery), such as electric double layer capacitor.

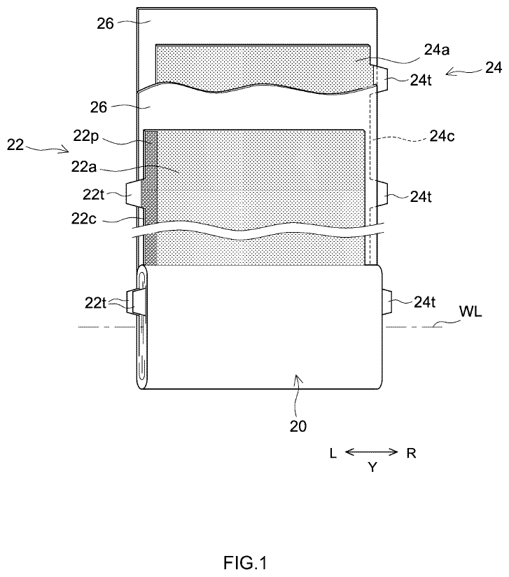

FIG. 1 is an exploded view that schematically shows a configuration of an electrode assembly 20, as an example of an electrode assembly used for an electric storage device. The electrode assembly 20 is a wound electrode assembly. The electrode assembly 20 is an usage example of an electrode manufactured by a laser processing method disclosed herein. As shown in FIG. 1, the electrode assembly 20 includes a positive electrode 22 formed in a strip-like shape (long sheet shape), a negative electrode 24 formed in a strip-like shape (long sheet shape), and two separators 26 formed in strip-like shapes (long sheet shapes). The positive electrode 22, the negative electrode 24, and two separators 26 are wound in a longitudinal direction with a winding axis WL treated as a center, under a state where respective parts in the longitudinal direction are aligned and laminated (arranged). Here, the winding axis WL is a width direction of the electrode (positive electrode 22 and negative electrode 24), which is orthogonal to the longitudinal direction of the electrode.

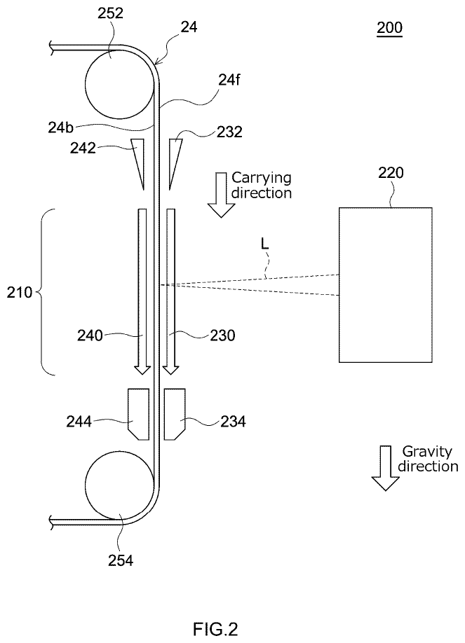

As shown in FIG. 1, the positive electrode 22 includes a positive electrode collecting foil 22c, a positive electrode active material layer 22a, and a protective layer 22p. The positive electrode active material layer 22a is arranged on one surface or both surfaces (here, both surfaces) of the positive electrode collecting foil 22c, and is arranged to extend in the longitudinal direction of the positive electrode 22. The protective layer 22p is arranged to extend in the longitudinal direction of the positive electrode 22, and arranged adjacent to the positive electrode active material layer 22a. Here, the protective layer 22p is arranged at one side (left side in FIG. 2) of the positive electrode active material layer 22a. On an edge part at one side (left side in FIG. 1) in the winding axis WL direction of the positive electrode collecting foil 22c (in other words, width direction of the positive electrode 22 orthogonal to the above described longitudinal side direction), plural positive electrode tabs 22t are provided. Each of the plural positive electrode tabs 22t protrudes toward one side (left side in FIG. 2) in the width direction of the positive electrode 22. The positive electrode tab 22t is configured to protrude to an outer side more than the separator 26 in the width direction of the electrode. The plural positive electrode tabs 22t are provided at intervals in the longitudinal direction of the positive electrode 22 (intermittently). The plural positive electrode tabs 22t are laminated at one of the end parts (left side in FIG. 1) in the width direction of the positive electrode 22, so as to configure a positive electrode tab group. The positive electrode tab group is connected to a positive electrode collecting body in the electric storage device.

In FIG. 1, the positive electrode tab 22t in a plane view is formed in a trapezoidal shape whose width becomes narrower in a protruding direction of the positive electrode tab 22t. However, the shape of the positive electrode tab 22t is not particularly restricted, and the shape might be, for example, a triangle shape, a rectangular shape, a polygonal shape, a circular arc shape, or the like. In addition, a corner of the positive electrode tab 22t might be formed in an R shape.

As the positive electrode collecting foil 22c configuring the positive electrode 22, it is possible to use a foil made of metal, and thus to use, for example, aluminum foil, or the like. The positive electrode active material layer 22a contains a positive electrode active material. The positive electrode active material can be suitably changed, on the basis of a type of used electric storage device. In a case where the electric storage device is a lithium ion secondary battery, it is possible to use, for example, lithium composite metal oxide (for example, LiNi1/3Co1/3Mn1/3O2, LiNiO2, LiCoO2, LiFeO2, LiMn2O4, LiNi0·5Mn1·5O4, LiCrMnO4, LiFePO4, or the like), or the like, which has a layer structure, a spinel structure, an olivine structure, or the like. In addition, the positive electrode active material layer 22a might contain an electrically conducting material, a binder, or the like. As the electrically conducting material, for example, it is possible to suitably use a carbon black, such as acetylene black (AB), or the other carbon material (graphite, or the like). As the binder, for example, it is possible to use polyvinylidene fluoride (PVdF), or the like.

An average thickness of the positive electrode active material layer 22a, which is not particularly restricted, is, for example, equal to or more than 10 μm and not more than 300 μm, or is preferably equal to or more than 20 μm and not more than 200 μm.

Incidentally, in the present specification, “average thickness” can be measured by a reflection type laser displacement gauge, or the like (said condition is the same even in below descriptions).

The protective layer 22p might contain, for example, an inorganic particle having an insulating property, a binder, a carbon material, or the like. As the inorganic particle having the insulating property, for example, it is possible to use alumina, silica, or the like. As the binder, for example, it is possible to use PVdF, or the like. As the carbon material, for example, it is possible to use carbon black, graphite, or the like.

An average thickness of the protective layer 22p, which is not particularly restricted, might be, for example, equal to or more than 3 μm, or might be equal to or more than 5 μm. The average thickness of the protective layer 22p is preferably equal to or less than the average thickness of the positive electrode active material layer 22a, or might be, for example, equal to or less than 50 μm.

The positive electrode active material layer 22a can be formed by dispersing the positive electrode active material and a material used as needed (electrically conducting material, binder, or the like) into a suitable solvent (for example, N-methyl-2-pyrrolidone: NMP), by preparing a composition in a paste form (or slurry form), by coating a surface of the positive electrode collecting foil 22c with a suitable amount of the composition, and then by drying the resultant.

As shown in FIG. 1, the negative electrode 24 includes a negative electrode collecting foil 24c and a negative electrode active material layer 24a. The negative electrode active material layer 24a is arranged on one surface or both surfaces (here, both surfaces) of the negative electrode collecting foil 24c, and is arranged to extend in the longitudinal direction of the negative electrode 24. On an edge part at one side (right side in FIG. 1) in the winding axis WL direction of the negative electrode collecting foil 24c (in other words, width direction of the negative electrode 24 orthogonal to the above described longitudinal side direction), plural negative electrode tabs 24t are provided. Each of the plural negative electrode tabs 24t is configured to protrude toward one side (right side in FIG. 2) in the width direction of the negative electrode 24. Here, the protruding direction of the negative electrode tab 24t is directed in an opposite direction to the protruding direction of the positive electrode tab 22t, regarding the width direction of the electrode. The negative electrode tab 24t is configured to protrude to the outer side more than the separator 26 in the width direction of the electrode. The plural negative electrode tabs 24t are provided at the intervals in the longitudinal direction of the negative electrode 24 (intermittently). The plural negative electrode tabs 24t are laminated at one of end parts (right side in FIG. 1) in the width direction of the negative electrode 24, so as to configure a negative electrode tab group. The negative electrode tab group is connected to a negative electrode collecting body in the electric storage device.

As the negative electrode collecting foil 24c configuring the negative electrode 24, it is possible to use a foil made of metal, and thus to use, for example, a copper foil, or the like. The negative electrode active material layer 24a contains a negative electrode active material. The negative electrode active material can be suitably changed, on the basis of a type of used electric storage device. In a case where the electric storage device is a lithium ion secondary battery, it is possible to use, for example, a carbon material, such as graphite, hard carbon, and soft carbon. In addition, the negative electrode active material layer 24a might further contain a binder, a thickening agent, or the like. As the binder, for example, it is possible to use styrene butadiene rubber (SBR), or the like. As the thickening agent, for example, it is possible to use carboxymethyl cellulose (CMC), or the like.

An average thickness of the negative electrode active material layer 24a, which is not particularly restricted, is, for example, equal to or more than 10 μm and not more than 500 μm, or is preferably equal to or more than 20 μm and not more than 300 μm.

The negative electrode active material layer 24a can be formed, for example, by dispersing the negative electrode active material and a material used as needed (binder, or the like) into a suitable solvent (for example, ion exchange water), by preparing a composition in a paste form (or slurry form), by coating a surface of the negative electrode collecting foil 24c with a suitable amount of the composition, and then drying the resultant.

The separator 26 can be suitably changed on the basis of the type of the electric storage device. In a case where the electric storage device is a lithium ion secondary battery, for example, it is possible to use a fine porous sheet having an insulating property, and it is possible, for example, to use fine porous resin sheet consisting of a resin, such as polyethylene (PE) and polypropylene (PP). The fine porous resin sheet described above might be configured with a single layer structure, or might be configured with plural layers structure which has two or more layers (for example, three layers structure in which PP layers are laminated on both surfaces of a PE layer). In addition, the separator 26 might include a heat resistance layer (HRL). Incidentally, it is sufficient for the separator 26 to be a member or portion that has a function of establishing an insulation between the positive electrode 22 and the negative electrode 24, and thus it is not always necessary for the separator 26 to be formed in the strip-like shape.

Below, it will be described about the laser processing method of the strip-like shaped electrode disclosed herein. The laser processing method is used, for example, when the positive electrode tab 22t or the negative electrode tab 24t is formed. In explanation described below, the negative electrode 24 is used as an example of the strip-like shaped electrode for explanation, but the same is true to the positive electrode 22.

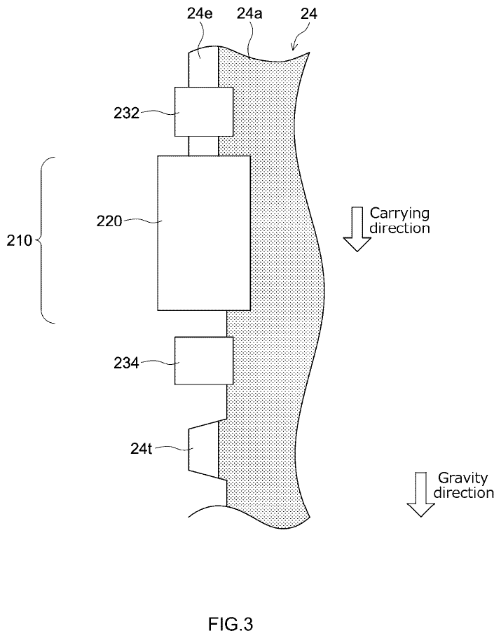

FIG. 2 is a front view that shows a schematic configuration of a laser processing apparatus 200 in accordance with one embodiment. FIG. 3 is a right side view of the laser processing apparatus 200 shown in FIG. 2. The laser processing method disclosed herein is, for example, implemented with the laser processing apparatus 200 shown in FIG. 2. The laser processing apparatus 200 includes a processing area 210 for performing laser radiation on a surface of the strip-like shaped electrode. In addition, here, the laser processing apparatus 200 includes a laser supplying part 220, a strip-like shaped electrode carrying means, a first air flow supplying means, and a second air flow supplying means.

As shown in FIG. 2, regarding the laser processing apparatus 200, the processing area 210 is previously set to match a position of the laser radiated from the laser supplying part 220. The laser processing apparatus 200 includes a carrying means for carrying the strip-like shaped electrode to the longitudinal direction of this electrode. The laser processing apparatus 200 in accordance with the present embodiment includes a first roll 252 and a second roll 254. The first roll 252 and the second roll 254 are arranged respectively at positions away from each other to sandwich the processing area 210. The negative electrode 24 is carried out from the first roll 252 toward the second roll 254. The negative electrode 24 includes a first surface 24f being a front surface onto which the laser radiation is performed, and includes a second surface 24b being a rear surface of the first surface 24f. The second surface 24b of the negative electrode 24 comes into contact with the first roll 252 and the second roll 254. The first roll 252 and/or the second roll 254 might be driven to rotate itself so as to carry the negative electrode 24. In addition, the first roll 252 and/or the second roll 254 might not be driven, and then, for example, a power source might be disposed at a downstream side of the second roll 254 to carry the negative electrode 24.

As shown in FIG. 3, the negative electrode 24 includes a negative electrode active material layer 24a, and includes a negative electrode collecting foil exposed part 24e arranged adjacent to the negative electrode active material layer 24a and configured to extend in a longitudinal direction. The negative electrode collecting foil exposed part 24e is a portion where the negative electrode active material layer 24a is not arranged and where the negative electrode collecting foil 24c is exposed. The negative electrode collecting foil exposed part 24e is provided on at least one of end parts in the width direction of the negative electrode 24. The negative electrode collecting foil exposed part 24e becomes at least a part of the negative electrode tab 24t when the negative electrode tab 24t is formed by the laser processing.

In the processing area 210, a first air flow 230 flowing on the first surface 24f of the negative electrode 24 and a second air flow 240 flowing on the second surface 24b of the negative electrode 24 are formed. By forming the first air flow 230 and the second air flow 240, the negative electrode 24 is kept under a state of being sandwiched in a thickness direction of the negative electrode 24 so as to be held. Then, while this state is still kept, a laser light L is radiated onto the first surface 24f of the negative electrode 24 in the processing area 210. The laser light L is supplied from the laser supplying part 220. By doing this, it is possible to suppress vibration of the negative electrode 24 in its thickness direction caused by the laser radiation performed on the negative electrode 24. It is supposed that the vibration described above is caused by reaction force in response to scattering of a dust, such as fume, generated when the negative electrode 24 is subjected to the laser radiation. In addition, since the dust, such as fume, blows away by the first air flow 230 and the second air flow 240, it is possible to suppress reduction in a light condensing property of the laser light L due to the dust, such as fume.

It is preferable that the first air flow 230 at the first surface 24f of the negative electrode 24 passes through a portion where the laser light L is radiated (referred to as “laser radiation part”, too), and that the second air flow 240 at the second surface 24b of the negative electrode 24 passes through the laser radiation part. In that case, the laser light L passes through the first air flow 230 comes into contact with the first surface 24f of the negative electrode 24, and then passes through the second air flow 240 after the negative electrode 24 is fused and cut. By implementing the configuration described above, it is possible to suitably suppress the vibration of the negative electrode 24 on the laser radiation part. In addition, it is possible to suitably suppress the reduction in the light condensing property of the laser light L caused by the dust, such as fume. Incidentally, the laser radiation part in the present specification means not only a surface portion of the electrode at a side irradiated with the laser light L, but also the whole thickness of the electrode with respect to the surface portion with which the laser light L comes into contact.

Flowing directions of the first air flow 230 and the second air flow 240 are not particularly restricted, if they pass through a position near the laser radiation part of the negative electrode 24. It is suitable that the first air flow 230 and the second air flow 240 are configured to flow in the same direction. By doing this, it is possible to further properly sandwich the laser radiation part of the negative electrode 24 so as to hold it. In the present embodiment, as shown in FIG. 2, the first air flow 230 and the second air flow 240 are configured to flow along a carrying direction of the negative electrode 24 on the processing area 210. By doing this, it is possible to make the dust, such as fume, generated on the laser radiation part blow away to downstream side at which a laser cut operation is completed, and thus it is possible to suppress the dust, such as fume, from sticking on a surface of the negative electrode 24 before the laser cut operation.

It is preferable that the first air flow 230 and the second air flow 240 are configured to flow at the same speed. By doing this, it is possible to properly suppress the negative electrode 24 from being bent on the processing area 210.

In one aspect of the present technique, it is preferable that a speed of the first air flow 230 and a speed of the second air flow 240 are faster than a carrying speed of the negative electrode 24. By doing this, it is possible not only to properly hold the negative electrode 24 on the processing area 210, but also to properly remove the dust, such as fume.

It is preferable that the first air flow 230 is a laminar flow configured to flow along the first surface 24f of the negative electrode 24. In addition, it is preferable that the second air flow 240 is a laminar flow configured to flow along the second surface 24b of the negative electrode 24. By doing this, on the processing area 210, the negative electrode 24 can be held, stably. Incidentally, the laminar flow means a steady flow configured to flow in the flowing direction with regularity. The laminar flow semantically covers, for example, an air flow configured to flow at a constant speed in a constant direction.

Gas forming the first air flow 230 and the second air flow 240, which is not particularly restricted, might be, for example, air or inactivation gas. As the inactivation gas, it is possible, for example, to use nitrogen gas, argon gas, or the like.

As shown in FIG. 2, the laser processing apparatus 200 in accordance with the present embodiment includes a first flow out port 232 as a means for supplying the first air flow 230. The first flow out port 232 is arranged at the first surface 24f side of the negative electrode 24. Air released from the first flow out port 232 flows as the first air flow 230 over the first surface 24f of the negative electrode 24.

As shown in FIG. 2, the laser processing apparatus 200 in accordance with the present embodiment includes a first suction port 234. The first suction port 234 sucks up the first air flow 230 having flown over the first surface 24f of the negative electrode 24 within the processing area 210. The first suction port 234 is arranged at the first surface 24f side of the negative electrode 24 to be opposed to the first flow out port 232 via the processing area 210. As described above, by making the first suction port 234 suck up the air released from the first flow out port 232, the first air flow 230 can be formed stably in a direction from the first flow out port 232 to the first suction port 234. In addition, the dust, such as fume, is carried by the first air flow 230 to the first suction port 234, and thus it is possible to efficiently collect the dust, such as fume. Incidentally, as shown in FIG. 2, regarding the present embodiment, with respect to the carrying direction of the negative electrode 24, the first flow out port 232 is arranged at the upstream side of the processing area 210, and the first suction port 234 is arranged at the downstream side of the processing area 210. By doing this, it is possible to implement the first air flow 230 along the carrying direction of the negative electrode 24.

As shown in FIG. 2, the laser processing apparatus 200 in accordance with the present embodiment includes a second flow out port 242 as a means for supplying the second air flow 240. The second flow out port 242 is arranged at the second surface 24b side of the negative electrode 24. Air released from the second flow out port 242 flows as the second air flow 240 over the second surface 24b of the negative electrode 24.

As shown in FIG. 2, the laser processing apparatus 200 in accordance with the present embodiment includes a second suction port 244. The second suction port 244 sucks up the second air flow 240 having flown over the second surface 24b of the negative electrode 24 within the processing area 210. The second suction port 244 is arranged at the second surface 24b side of the negative electrode 24 to be opposed to the second flow out port 242 via the processing area 210. As described above, by making the second suction port 244 suck up the air released from the second flow out port 242, the second air flow 240 can be formed stably in a direction from the second flow out port 242 to the second suction port 244. In addition, the dust, such as fume, is carried by the second air flow 240 to the second suction port 244, and thus it is possible to efficiently collect the dust, such as fume. Incidentally, as shown in FIG. 2, regarding the present embodiment, with respect to the carrying direction of the negative electrode 24, the second flow out port 242 is arranged at the upstream side of the processing area 210, and the second suction port 244 is arranged at the downstream side of the processing area 210. By doing this, it is possible to implement the second air flow 240 along the carrying direction of the negative electrode 24.

Incidentally, the first flow out port 232 and the second flow out port 242 might be flow out ports independent from each other, or the first flow out port 232 and the second flow out port 242 might be together configured to be continuous one flow out port. In addition, the first suction port 234 and the second suction port 244 might be suction ports independent from each other, or the first suction port 234 and the second suction port 244 might be together configured to be continuous one suction port.

The carrying direction of the negative electrode 24 on the processing area 210 is not particularly restricted, but as shown in FIG. 2, it is preferable that the carrying direction is the gravity direction. By doing this, the dust, such as fume, generated on the laser radiation part becomes to easily flow in the gravity direction, and thus it is possible to suppress the reduction in the light condensing property of the laser light L due to the dust, such as fume. Incidentally, in a case where the first air flow 230 and the second air flow 240 are configured to flow along the carrying direction of the negative electrode 24 on the processing area 210, it is possible that the dust, such as fume, is further suitably removed, and thus it is possible to further properly suppress the reduction in the light condensing property of the laser light L due to the dust, such as fume.

The laser supplying part 220 is configured to supply the laser light L to the processing area 210. A configuration of the laser supplying part 220 might be similar to conventional one utilized for laser cut. As the illustration is omitted, the laser supplying part includes, for example, a laser oscillation device, a laser head, or the like. The laser oscillation device is an apparatus that generates laser which is a heat source for welding. The laser head is a portion that radiates the laser, generated by the laser oscillation device, as the laser light L. The laser light path can be configured, for example, with a mirror, a light fiber, or the like. As the laser light L, it is possible to use, for example, YAG laser, fiber laser, CO2 laser, semiconductor laser, disk laser, or the like.

On the processing area 210, the laser light L is radiated to the negative electrode active material layer 24a or the negative electrode collecting foil exposed part 24e, so as to cut the irradiated portion. As shown in FIG. 3, at the downstream side of the processing area 210, the negative electrode tab 24t is formed. A laser cut operation might be performed on the negative electrode collecting foil exposed part 24e to perform processing so as to make the negative electrode tab 24t be configured with the negative electrode collecting foil exposed part 24e, but it is preferable that, as shown in FIG. 3, processing is performed to make the negative electrode tab 24t include the negative electrode collecting foil exposed part 24e and the negative electrode active material layer 24a. For example, it is preferable that the laser light L is radiated to an end part of the negative electrode active material layer 24a, scanning with the laser light L is performed to the negative electrode collecting foil exposed part 24e side at a timing of forming the negative electrode tab 24t, and the scanning with the laser light L is performed to the negative electrode active material layer 24a side at a suitable timing. Incidentally, a scanning direction of the laser light L is suitably adjusted on the basis of a shape, size, or the like of the negative electrode tab 24t. For example, by implementing a configuration of controlling a carrying speed of the negative electrode 24 and the laser supplying part in an interlocked manner, it is possible to intermittently form the negative electrode tabs 24t at the end part of the negative electrode 24 in the width direction.

In accordance with the laser processing method disclosed herein, the negative electrode 24 on the processing area 210 can be supported in a sandwiched manner by the first air flow 230 and the second air flow 240, and thus it is not necessary to provide a guide, which directly sandwiches and supports the negative electrode 24, near the processing area 210. In a case where the guide is provided, the dust, such as fume, might stick to the guide, the sticking dust might interfere with the carried electrode, and thus a fear of damaging the electrode might be caused. Therefore, it is possible by using the laser processing method disclosed herein to solve the above described fear.

Incidentally, in a case where the positive electrode 22 is used as the strip-like shaped electrode, it can be understood by replacing “negative electrode” with “positive electrode” in the technical explanation described above. However, a laser light L radiation position might be on the protective layer 22p, instead of the positive electrode active material layer 22a, and the positive electrode tab 22t might be configured to include the positive electrode collecting foil exposed part and the protective layer 22p.

In addition, the strip-like shaped electrode can be used not only for the wound electrode assembly, but also for a laminate electrode assembly. In a case that the strip-like shaped electrode is used for the laminate electrode assembly, it is possible to construct the laminate electrode assembly by cutting the strip-like shaped electrode along the width direction so as to obtain plural electrode sheets, each including the tab, and then by laminating the negative electrode and the positive electrode via the separator.

Above, some embodiments of the present technique have been explained, but the above described embodiments are merely examples.

The present technique can be implemented in various different forms. The technique recited in the appended claims includes variously deformed or changed versions of the embodiments that have been illustrated above.

While described above, it is possible as a particular aspect of the herein disclosed technique to use one recited by each of below described items.

Item 1: A method for performing a laser processing on a strip-like shaped electrode, comprising: carrying the strip-like shaped electrode to a previously set processing area in a longitudinal direction; and performing a laser radiation on a surface of the electrode in the processing area under a state where a first air flow configured to flow on one surface of the electrode and a second air flow configured to flow on the other surface of the electrode are formed.
Item 2: The laser processing method recited in item 1, wherein the first air flow having flown on the one surface of the electrode is sucked up by a first suction port, and the second air flow having flown on the other surface of the electrode is sucked up by a second suction port.
Item 3: The laser processing method recited in item 1 or 2, wherein the first air flow is a laminar flow configured to flow along the one surface of the electrode, and the second air flow is a laminar flow configured to flow along the other surface of the electrode.
Item 4: The laser processing method according to any one of items 1 to 3, wherein the first air flow and the second air flow are configured to flow along a carrying direction of the electrode.
Item 5: The laser processing method according to any one of items 1 to 4, wherein a carrying direction of the electrode in the processing area is a gravity direction.

What is claimed is:

1. A method for performing a laser processing on a strip-like shaped electrode, comprising:
a step of carrying the electrode to a previously set processing area in a longitudinal direction; and
a step of performing a laser radiation on a surface of the electrode in the processing area under a state where a first air flow configured to flow on one surface of the electrode and a second air flow configured to flow on the other surface of the electrode are formed.

2. The laser processing method according to claim 1, wherein
the first air flow having flown on the one surface of the electrode is sucked up by a first suction port, and the second air flow having flown on the other surface of the electrode is sucked up by a second suction port.

3. The laser processing method according to claim 1, wherein
the first air flow is a laminar flow configured to flow along the one surface of the electrode, and the second air flow is a laminar flow configured to flow along the other surface of the electrode.

4. The laser processing method according to claim 2, wherein
the first air flow is a laminar flow configured to flow along the one surface of the electrode, and the second air flow is a laminar flow configured to flow along the other surface of the electrode.

5. The laser processing method according to claim 1, wherein
the first air flow and the second air flow are configured to flow along a carrying direction of the electrode.

6. The laser processing method according to claim 2, wherein
the first air flow and the second air flow are configured to flow along a carrying direction of the electrode.

7. The Laser processing method according to claim 1, wherein
a carrying direction of the electrode in the processing area is a gravity direction.

8. The laser processing method according to claim 2, wherein
a carrying direction of the electrode in the processing area is a gravity direction.
